(19) United States
(12) Patent Application Publication
(10) Pub. No.: US 2012/0074271 A1
(43) Pub. Date: Mar. 29, 2012

(54) Electronic book, tablet computer and smart phone stand

(76) Inventor: Helmut Goetz, Fair Lawn, NJ (US)

(21) Appl. No.: 12/924,330

(22) Filed: Sep. 24, 2010

(51) Int. Cl. F16M 11/04; F16M 11/22

(52) U.S. Cl. 248/121; 248/176.1

(57) ABSTRACT

A stand which holds an electronic device such as the electronic book such as the “Kindle” manufactured and sold by Amazon, a tablet computer such as the “iPad” manufactured and sold by Apple or a smart phone such as the “iPhone” manufactured and sold by Apple, and maintains said device in a comfortable and convenient viewing position is disclosed. Said stand consists of a lightweight material such as steel, stainless steel or plastic which is simple and inexpensive to manufacture and sell and is also simple to use. One embodiment of said stand is manufactured to be collapsible and easily portable, manufactured in two parts to fold flat.

### FIELD OF THE INVENTION

The present invention relates to the field of stands and supports designed to hold and display electronic books and smart phones for easy viewing. More particularly, this invention relates to a stand that supports and displays electronic books such as the electronic book sold by Amazon under the trademark “Kindle,” the tablet computer manufactured and sold by Apple under the trademark “iPad” and smart phones such as the “iPhone” manufactured and sold by Apple.

### BACKGROUND OF THE INVENTION

Stands and supports are widely available that allow readers of conventional books to place their reading material at a comfortable reading level and prevent eyestrain and fatigue of the neck, arms and hands. With the increasing availability and widespread use of electronic books, smart phones and tablet computers, people are demanding stands or supports for these devices.

Many types of stands and supports are available, using all manner of construction and materials, that will hold and display books. These book stands and supports are generally unsuitable for the purpose of holding and displaying electronic devices such as e-books, tablet computers and smart phones. A few specialized stands have been developed recently, but all suffer from disadvantages such as being excessively costly, cumbersome and complicated. Book stands such as those disclosed by certain published patents, for example, Pub. No. US 2004/0188588; Pub. No. US 2006/0249646; Pub. No. US 2007/0045503; Pub. No. US 2004/0188588; Pub. No. US 2009/0207589; and Pub. No. US 2009/0212191 address issues of holding and supporting books but are not suitable for displaying the screens of electronic devices. Pub. No. US 2008/0006749 discloses a multi-purpose utility stand suitable for laptops but is heavy, clumsy and cumbersome Pub. No. US 2008/0087789 discloses an adjustable reading and viewing support suitable for books, cell phones, audio players and other objects providing a source of information or entertainment. This device is also unsuitable because it makes difficult for the user to maintain the viewed device in a comfortable viewing position.

An improved stand is needed which is easy to manufacture and use, is lightweight and inexpensive and allows the user to maintain an electronic book, tablet computer and smart phone in a comfortable and convenient viewing position.

### SUMMARY OF THE INVENTION

It is therefore an object of the present invention to provide a new and improved stand which holds and maintains an electronic book, tablet computer or smart phone in a comfortable and convenient viewing position.

It is a further object of the present invention to provide a new and improved stand which holds and maintains an electronic book, tablet computer or smart phone in a comfortable and convenient viewing position and is light, inexpensive and simple to manufacture.

It is a further object of the present invention to provide a new and improved stand which holds and maintains an electronic book, tablet computer or smart phone in a comfortable and convenient viewing position and is light, inexpensive to purchase and simple to use.

It is a further object of the present invention to provide a new and improved stand which holds and maintains an electronic book such as the “Kindle” sold by Amazon in a comfortable and convenient viewing position and is inexpensive and simple to manufacture.

It is a further object of the present invention to provide a new and improved stand which holds and maintains a tablet computer such as the “iPad” manufactured and sold by Apple in a comfortable and convenient viewing position and is inexpensive and simple to manufacture.

It is a further object of the present invention to provide a new and improved stand which holds and maintains a smart phone such as the “iPhone” manufactured and sold by Apple in a comfortable and convenient viewing position and is inexpensive and simple to manufacture.

It is a further object of the present invention to provide a new and improved stand which holds and maintains a device such as an electronic book, tablet computer or smart phone in a comfortable and convenient viewing position and allows said device to connect to an electrical plug or computer source to allow for charging the device.

It is a further object of the present invention to provide a new and improved stand which holds and maintains an electronic book, tablet computer or smart phone in a comfortable and convenient viewing position and is easy to transport.

These and other features of the invention can be further understood by reference to the following drawings.

### BRIEF DESCRIPTION OF THE DRAWINGS

FIG. 1 shows the smart phone stand in accordance with one embodiment of the present invention, showing the two component pieces in a collapsed state.

FIG. 2 shows the electronic book or tablet computer stand in accordance with one embodiment of the present invention, showing the two collapsible component pieces after assembly in a rear-oblique view.

FIG. 3 shows the electronic book or tablet computer stand in accordance with one embodiment of the present invention, showing the two collapsible component pieces after assembly in a front-oblique view.

FIG. 4 shows the electronic book or tablet computer stand in accordance with another embodiment of the present invention, showing the two collapsible component pieces after assembly in a front-oblique view.

FIG. 5 shows the electronic book or tablet computer stand in accordance with one embodiment of the present invention, showing one of the two collapsible component pieces before assembly in top view.

FIG. 6 shows the electronic book or tablet computer stand in accordance with another embodiment of the present invention, showing the two collapsible component pieces after assembly in a front-oblique view.

FIG. 7 shows the electronic book or tablet computer stand in accordance with one embodiment of the present invention, showing the second of the two collapsible component pieces before assembly in side view.

FIG. 8 shows the smart phone stand in accordance with one embodiment of the present invention, showing a top view of the piece before bending or molding the piece into the finished shape.

FIG. 9 shows the smart phone stand in accordance with one embodiment of the present invention, showing a top view of the piece after bending or molding the piece into the finished shape.

FIG. 10 shows the smart phone stand in accordance with one embodiment of the present invention, showing a top view of the piece after bending or molding the piece into the finished shape.

FIG. 11 shows the electronic book or tablet computer stand in accordance with another embodiment of the present invention, showing the solid non-collapsible component piece in a rear-oblique view.

FIG. 12 shows the electronic book or tablet computer stand in accordance with another embodiment of the present invention, showing the solid non-collapsible component piece in a front-oblique view.

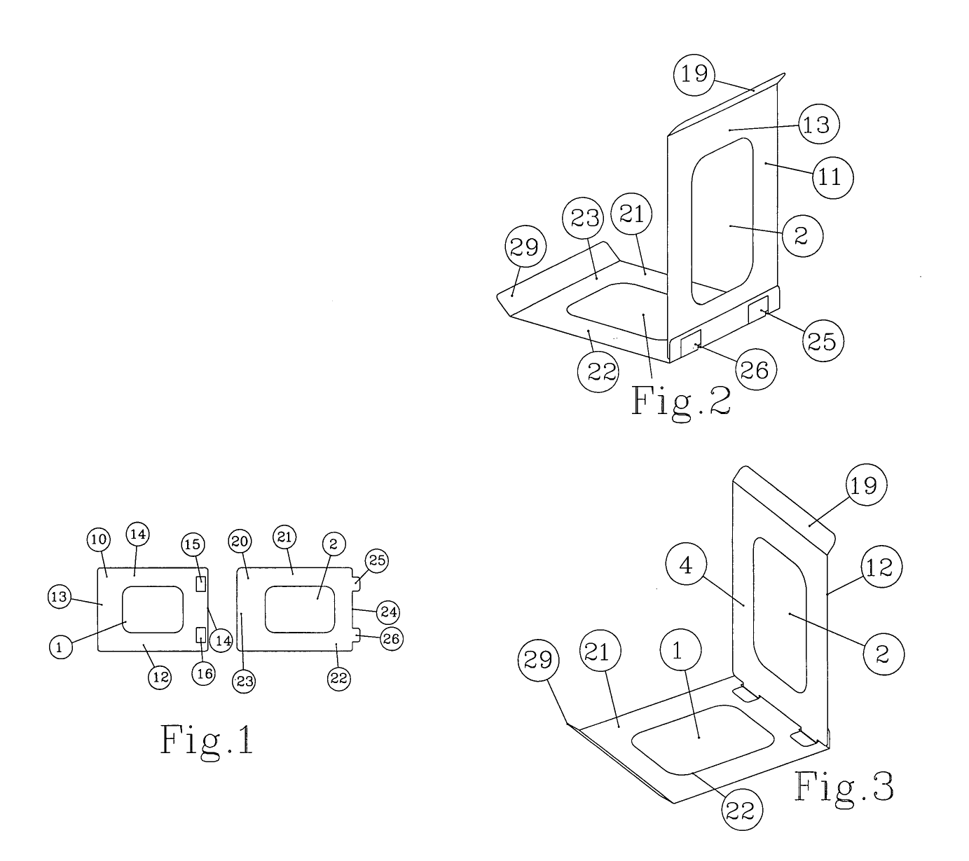

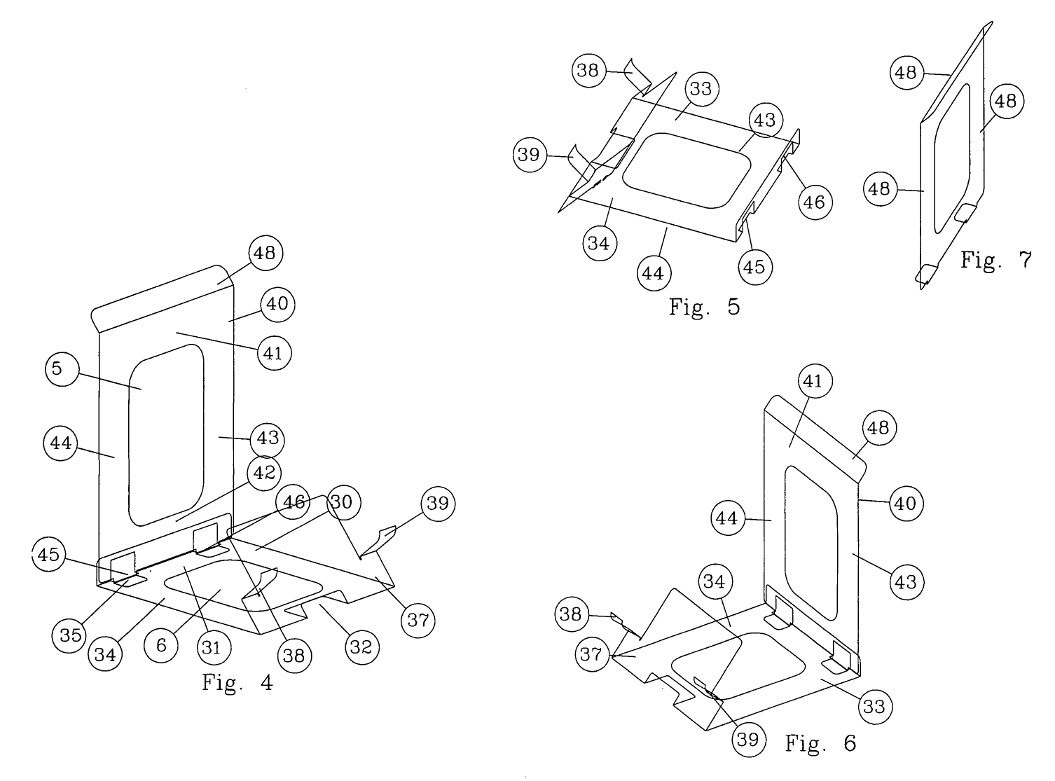

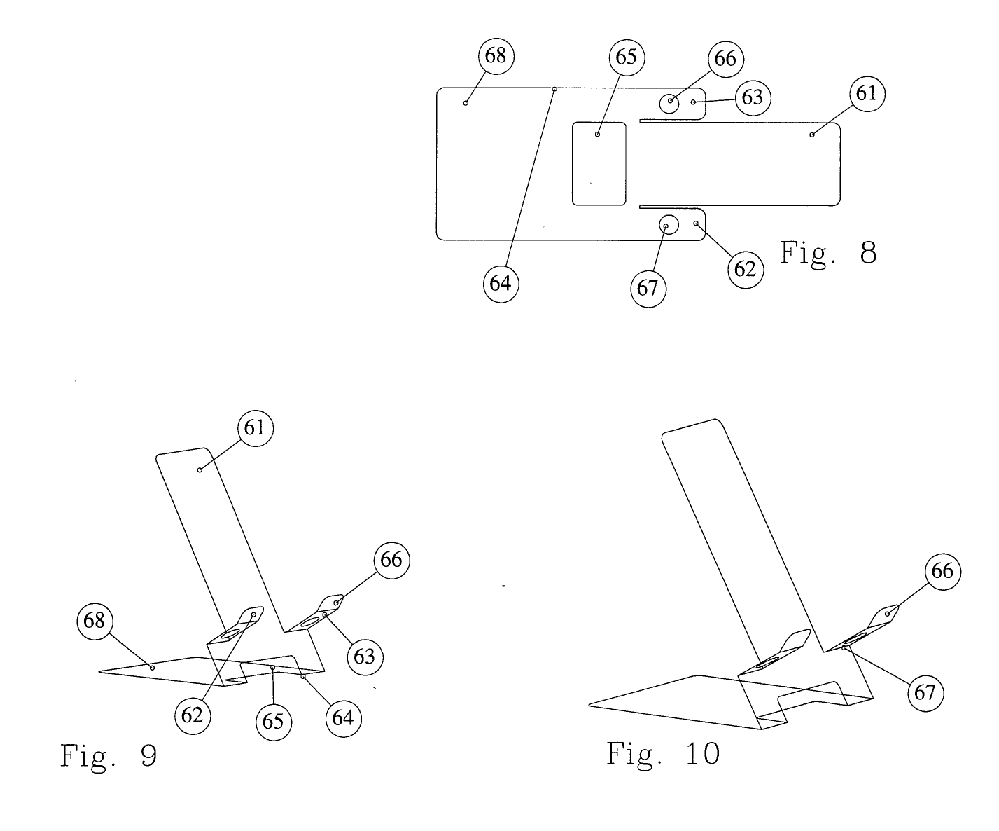

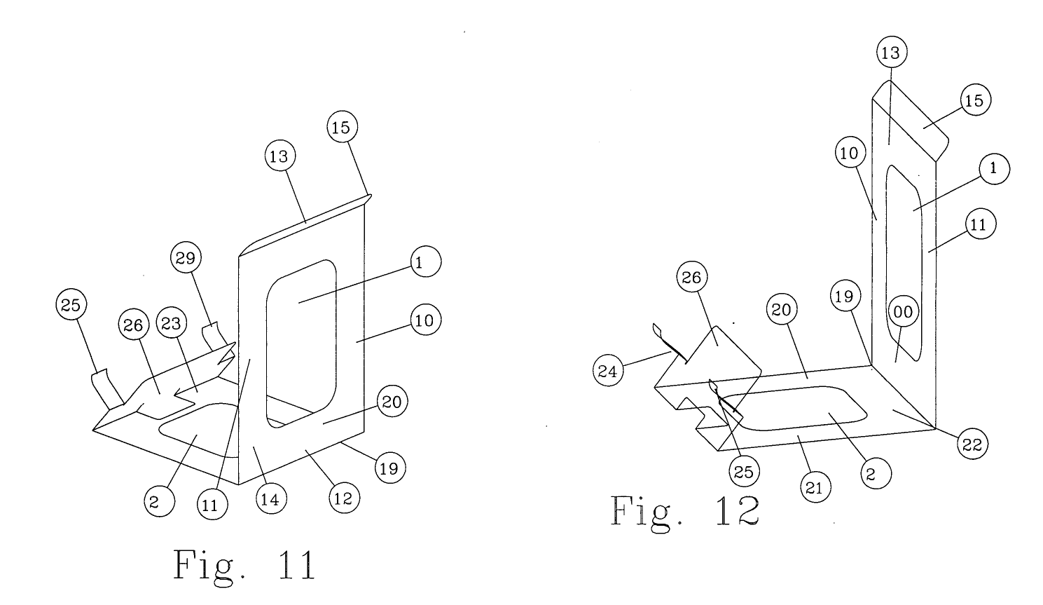

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A stand which holds and maintains an electronic book, tablet computer or smart phone in a comfortable and convenient viewing position, comprising:
one piece if material having a front panel with a front surface for receiving an electronic book or other electronic device having a display screen, said panel having projecting strips at the bottom of said panel to hold said device;
said piece of material having a base to support said stand;
said piece of material having a rear panel to stabilize said stand and support said electronic device.

2. The stand according to claim 1, wherein the material used for construction of said stand is steel.

3. The stand according to claim 1, wherein the material used for construction of said stand is stainless steel.

4. The stand according to claim 1, wherein the material used for construction of said stand is plastic.

5. A foldable stand which holds and maintains an electronic device such as a smart phone in a comfortable and convenient viewing position, comprising:
a first piece of material forming a base to support said stand and having two slots to receive two tabs formed at the base of a second piece of material;
said second piece of material forming a rear panel to stabilize said stand and support said electronic device, removably attached to said first piece of material through the insertion of said tabs on the second piece of material into said slots on said first piece of material.

6. The stand according to claim 1, wherein the material used for construction of said stand is steel.

7. The stand according to claim 1, wherein the material used for construction of said stand is stainless steel.

8. The stand according to claim 1, wherein the material used for construction of said stand is plastic.

9. A foldable stand which holds and maintains an electronic device such as an electronic book or tablet computer in a comfortable and convenient viewing position, comprising:
a first piece of material forming a base to support said stand and having two slots to receive two tabs formed at the base of a second piece of material;
said second piece of material forming a rear panel to stabilize said stand and support said electronic device, removably attached to said first piece of material through the insertion of said tabs on the second piece of material into said slots on said first piece of material.

10. The stand according to claim 1, wherein the material used for construction of said stand is steel.

11. The stand according to claim 1, wherein the material used for construction of said stand is stainless steel.

12. The stand according to claim 1, wherein the material used for construction of said stand is plastic.

13. A stand which holds and maintains an electronic device such as a smart phone in a comfortable and convenient viewing position, comprising:
one piece if material having a front panel with a front surface for receiving an electronic device such as a smart phone, said panel having projecting strips at the bottom of said panel to hold said device;
said piece of material having a base to support said stand;
said piece of material having a rear panel to stabilize said stand and support said electronic device.

14. The stand according to claim 1, wherein the material used for construction of said stand is steel.

15. The stand according to claim 1, wherein the material used for construction of said stand is stainless steel.

16. The stand according to claim 1, wherein the material used for construction of said stand is plastic.
